(19) United States
(12) Patent Application Publication
(10) Pub. No.: US 2007/0103591 A1
(43) Pub. Date: May 10, 2007

(54) METHOD FOR MANAGING KEY OPERATION INFORMATION FOR A JOG KEY

(75) Inventor: Min-Young SONG, Seongnam-si (KR)

Correspondence Address: FISH & RICHARDSON P.C., P.O. BOX 1022, MINNEAPOLIS, MN, 55440-1022, US

(73) Assignee: LG ELECTRONICS, INC., Youngdungpo-gu (KR)

(21) Appl. No.: 11/555,983

(22) Filed: Nov. 2, 2006

(30) Foreign Application Priority Data
Nov. 4, 2005 (KR) 2005-0105354
Mar. 8, 2006 (KR) 2006-0021885

(51) Int. Cl. H04N 11/00

(52) U.S. Cl. 348/468

(57) ABSTRACT

An apparatus for managing input key operation information includes a key input unit configured to receive a key input signal from a jog key, e.g., such as a jog dial or jog stick. A controller is configured to determine whether the key input signal is a jog message signal and to extract control operation information from the key input signal if the key input signal is the jog message signal. The control operation information includes jog key control direction and a number of jog key control operations from the jog message signal.

### BACKGROUND

This description relates to organizing key operation information for a jog key, such as, for example, a jog dial or a jog stick control.

A variety of multimedia terminal devices include jog keys, such as a jog dial or a jog stick, that permit the user to control one or more functions of the terminal device, such as providing the user with the ability to navigate through menus or to scroll a cursor through a variety of positions. For example, a jog key is typically mounted on a telematics terminal which is installed in a vehicle to provide a variety of multimedia services. The jog key allows the user to easily perform a desired function, such as cursor positioning, through the simple operation of the jog key.

A jog message relating to information storage and transfer is generated each time a jog key is operated by the user. For example, when the jog key is operated ten times by the user to reposition a cursor in a navigation screen, a corresponding jog message is generated ten times. Accordingly, the operating speed of the jog key may exceed a conversion speed of a user interface. In this case, a previous key input value may be buffered and delivered with a predetermined time delay, thereby causing a message delay in which a jog message delivery is delayed, even though a key input is no longer being made by the user. If a jog message is generated whenever the jog key is operated by the user, an overall processing speed of the system may be lowered.

### SUMMARY

In one general aspect, an apparatus for managing input key operation information includes a key input unit configured to receive a key input signal from a jog key. A controller is configured to determine whether the key input signal is a jog message signal and to extract control operation information from the key input signal if the key input signal is the jog message signal. The control operation information includes jog key control direction and a number of jog key control operations from the jog message signal.

Implementations of this aspect may include one or more of the following features. For example, a counter may be configured to determine the number of jog key control operations. The apparatus may include a direction value storing unit configured to store operation direction information corresponding to the jog key control direction. The apparatus may include a message setting unit for setting at least one of the jog key control direction or the number of jog key control operations in the jog message signal. The jog key may be one or more of a jog dial or a jog stick. The key input unit may be configured to receive the key input signal within a predetermined time period of the jog key being operated by a user. The predetermined time period may be within a range of approximately 100 ms to 200 ms. The jog message signal may include a data format including a SIZE data area and a DATA data area, and information corresponding to the number of jog key control operations is stored within the SIZE area and information corresponding to the jog key control direction is stored in the “DATA” area.

The jog message signal may include a data format including one or more of a SRC data area, a MID data area, a DST data area, a COMM data area, a FUNC data area, a SIZE data area, a DATA data area, a COUNT data area, or a FLAG data area. The information corresponding to the number of jog key control operations may be stored in the COUNT area and information corresponding to the jog key control direction is stored in the FLAG area. Each of the SRC, MID, DST, COMM, FUNC and FLAG data areas may be allocated 1 byte, and/or each of the SIZE and COUNT data areas may be allocated 2 bytes, and the DATA area may be allocated 200 bytes.

In another general aspect, a method for managing key operation information includes receiving a jog message, and decoding the jog message. The jog message includes jog key control information corresponding to a control operation of a jog key. Jog key control information is extracted from the jog message. The jog key control information includes jog key control direction and a number of jog key control operations.

Implementations of this aspect may include one or more of the following features. For example, an operation state of the jog key may be displayed in response to the extracting the jog key control information from the jog message. The generation of the jog message may include counting the number of jog key control operations. The generation of the jog message includes storing operation direction information corresponding to the jog key control direction. The jog message may be received within a predetermined time period after the control operation of the jog key. The predetermined time period may be within a range of approximately 100 ms to 200 ms. The jog message may include a SIZE data area and a DATA data area, and information corresponding to the number of jog key control operations may be stored within the SIZE area and information corresponding to the jog key control direction may be stored in the “DATA” area.

The jog message may include one or more of a SRC data area, a MID data area, a DST data area, a COMM data area, a FUNC data area, a SIZE data area, a DATA data area, a COUNT data area, and/or a FLAG data area. The information corresponding to the number of jog key control operations may be stored in the COUNT area and information corresponding to the jog key control direction may be stored in the FLAG area.

One or more of the foregoing aspects permits efficient processing of an input operation of a jog key based on a single jog message containing operation information relating to positioning of the jog key, e.g., the operation direction and/or the number of jog key operations, such as number of turns of a jog dial. The jog message is generated when a jog dial and/or a jog stick is operated within a predetermined time period, thereby reducing processing delays associated with generating multiple job messages associated with multiple operations of the jog key.

Other features will be apparent from the following description, including the drawings, and the claims.

### BRIEF DESCRIPTION OF THE DRAWINGS

FIG. 1 is a block diagram of an exemplary apparatus for handling key operation information.

FIGS. 2a and 2b are diagrams illustrating exemplary data structure of a jog message.

FIG. 3 is a table of binary data representative of direction information in exemplary jog messages.

FIG. 4 is an exemplary view of a jog dial screen on a multimedia device.

FIG. 5 is a flowchart of an exemplary process for controlling key operation information.

### DETAILED DESCRIPTION

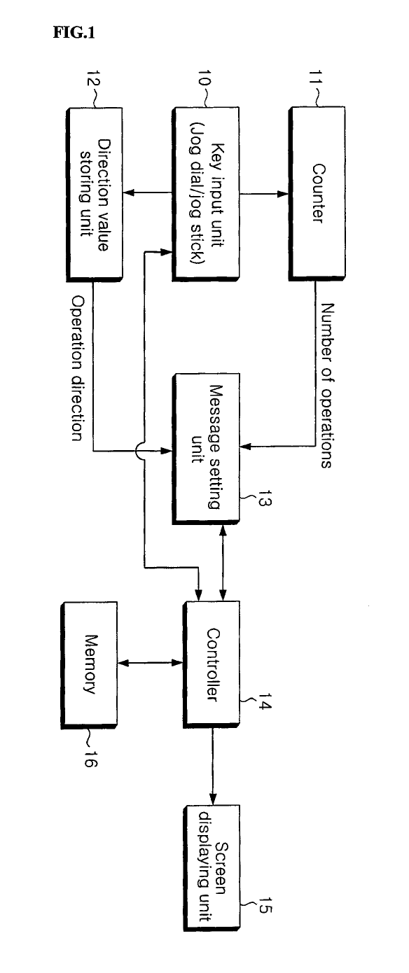

A method and apparatus for organizing key operation information is described in greater detail hereinafter with respect to FIGS. 1-5. An exemplary apparatus for managing key operation information will be described in connection with a terminal device, such as, for example, a telematics terminal mounted within a vehicle. However, the following example may be applied to various terminal devices, including, for example, digital cameras and multimedia players, such as satellite radios of DVD players.

Referring to FIG. 1, an exemplary apparatus for managing key operation information includes a key input unit 10 for inputting a predetermined function. The key input unit 10 may include a jog key, such as a jog dial and/or a jog stick with which a user can easily set or implement a control function. The apparatus further includes a counter 11 for counting the number of operations of the jog key generated in response to an operation of the key input unit 10, and a direction value storing unit 12 for storing information relating to an operation direction of the jog key as binary data, which is generated in response to an operation of the key input unit 10. For example, the information relating to the operation direction of the jog key may include binary data representative of a left, right, up, and/or down positioning of the jog key.

The apparatus includes a message setting unit 13 for storing the number of operations from the counter 11 and the operation direction read from the direction value storing unit 12 within corresponding sections of a jog message. The apparatus includes a controller 14 for extracting the operation direction and/or the number of operations which are included in the jog message by the message setting unit 13. An operation state of the key input unit 10 may be displayed on a screen display unit 15 of the apparatus.

The apparatus includes a memory 16 for storing a control program for control operations of the controller 14, information on a variety of modes of the terminal, and/or any other information or operational programs required to operate the device. For example, the memory 16 may temporarily store an operation scene of the key input unit 10. Alternatively, or additionally, the controller 14 may perform the function of the message setting unit 13. For example, the controller 14 may be configured to set the operation direction and the number of operations in the jog message and to extract the operation direction and the number of operations from the jog message. The operation direction and the number of operations would then be provided directly to the controller 14. In addition, or alternatively, the controller 14 may directly count the number of operations of the key input unit 10 and set the number of operations in the jog message.

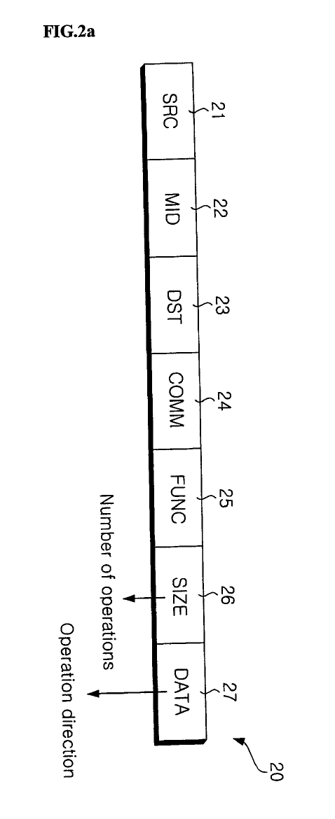

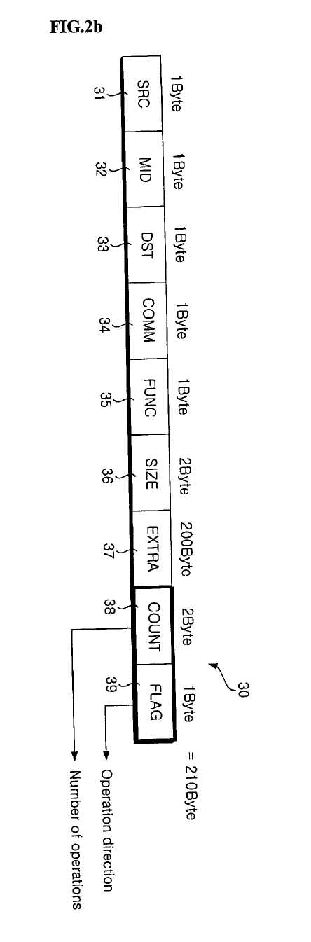

An exemplary structure of the jog message is shown in FIGS. 2A-2B. [[Shown as 2a and 2b in figures.] The jog message 20 of FIG. 2A has a format which includes a “SRC” area 21, a “MID” area 22, a “DST” area 23, a “COMM” area 24, a “FUNC” area 25, a “SIZE” area 26, and a “DATA” area 27. A module that intends to transmit a message is the source of the message and is specified in the “SRC” area 21. If there is a function to be performed midway, a module for performing the function is specified in the “MID” area 22. A final destination module is specified in the “DST” area 23, and function-related information is specified in the “COMM” area 24. Information to be delivered to the final destination is specified in the “FUNC” area 25. Size information of delivered data is specified in the “SIZE” area 26, and the transmitted data are specified in the “DATA” area 27. In addition, the number of operations responsive to the operation of the key input unit 10 is additionally specified in the “SIZE” area 26, and the operation direction is specified in the “DATA” area 27.

The structure of an exemplary jog message 30 of FIG. 2B has a data format including “SRC (1 Byte)” area 31, “MID (1 Byte)” area 32, “DST (1 Byte)” area 33, “COMM (1 Byte)” area 34, “FUNC (1 Byte)” area 35, “SIZE (2 Bytes)” area 36, “DATA (200 Bytes)” area 37, “COUNT (2 Bytes)” area 38, and “FLAG (1 Byte)” area 39. The jog message 20 (FIG. 2A) and the jog message 30 (FIG. 2A) are each a total of 210 bytes in size. However, in the jog message 30 of FIG. 2B, the number of operations responsive to the operation of the key input unit 10 is specified in the “COUNT (2 Bytes)” area 38, and the operation direction is specified in the “FLAG (1 Byte)” area 39.

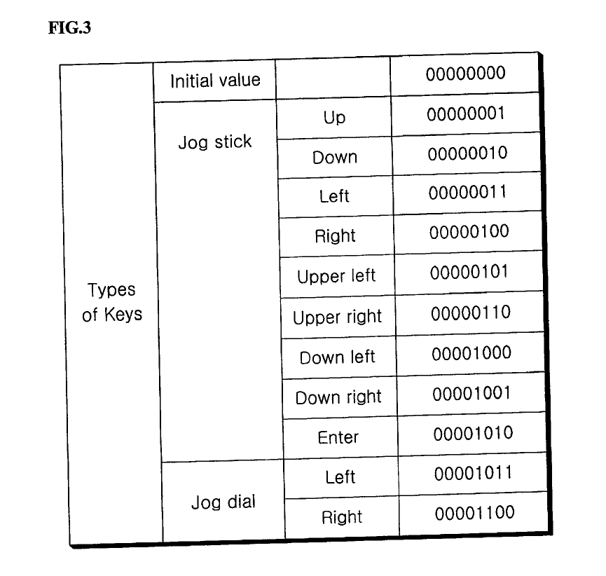

Referring to FIG. 3, direction information in a jog message within a direction value storing unit 12 is represented as binary data relating to jog key control values. The direction value storing unit 12 has binary data values that are set according to the operation direction of a jog dial and/or a jog stick of the key input unit 10. For example, a value “00000101” is provided if the jog stick is operated in an upper left direction, and a value “00001011” is provided if the jog dial is operated in a left direction. The operation directions of the jog stick are classified into up, down, left, right, upper left, upper right, lower left, lower right, and center. The operation directions of the jog dial are classified into left and right directions.

Although the key input unit 10 has been specifically described as a jog dial or jog stick, other types of keys may be employed as the key input unit and different values may be set according to the available operation directions of the designated key device. However, the key input unit 10 will be used hereinafter to describe a jog key, a jog dial and/or a jog stick.

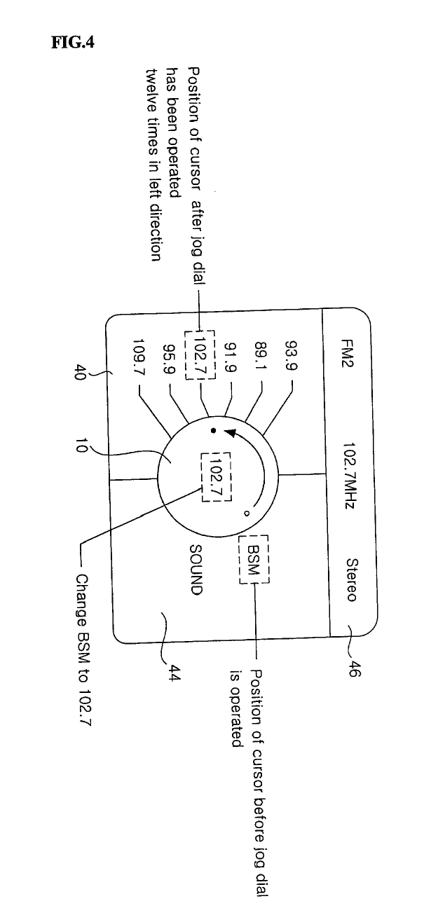

Referring to FIG. 4, an exemplary display screen for a multimedia device includes control options, e.g., a jog dial, for designating a broadcast channel for an FM stereo tuner. A channel of the FM stereo tuner is changed by operating the jog dial 10. The jog dial 10 is located at the center of the display screen, and a channel indicator 40 for indicating one or more channels is located in a left area with respect to the jog dial 10. A position of a cursor before the jog dial 10 is operated by the user is shown in a area 44 on the right side of the display screen, e.g., labeled as “BSM.” Further, a selection area designated as “SOUND” is provided to permit the user to select and set sound from one or more speakers associated with the FM stereo tuner. Further, a mode indicator 46 is located in an upper area of the display screen to indicate a current broadcast frequency, a broadcast channel, and/or mono/stereo operation.

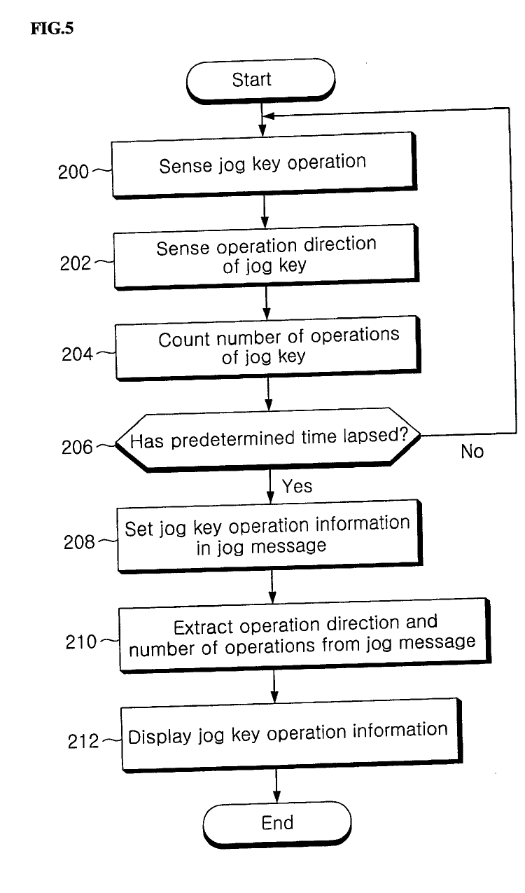

Referring to FIG. 5, an exemplary process for managing the key operation information with the apparatus of FIG. 1 is initiated by the user moving the jog key to a first position. For example, when a terminal is first turned on, a user operates the jog key 10 or a function selection key (not shown) so that a corresponding function is performed by the terminal, e.g., selecting a broadcast channel to be played by the multimedia terminal shown in FIG. 4.

In step 200, the apparatus is started by first sensing whether the key input unit 10, e.g., a jog key such as a jog dial and/or a jog stick, is operated in a state where the selected function is being performed, e.g., tuning the FM stereo tuner. If the jog key 10 is operated within a predetermined period of time, for example, such as within 100 ms to 200 ms, while the control function is being performed, the operation direction and/or the number of operations of the jog key 10 is/are generated. In step 202, information relating to the operation direction of the jog key is read out from the direction value storing unit 12. In step 204, the counter 11 determines the number of operations, and the information relating to the operation direction of the jog key output from the direction value storing unit 12 and the number of operations from the counter 11 are then output to the message setting unit 13 and/or controller 14.

For example, referring to FIG. 4, if the jog dial 10 is rotated twelve times in a left direction from the BSM position (i.e., an initial cursor position), the counter 11 counts the number of rotations occurring in the left direction. Further, if the jog dial 10 were a jog stick 10 operated twelve times, the counter 11 would count the number of operations in a single direction. For example, the number of operations corresponds to the number of actual operations of the jog key 10, such as the number of rotations of a jog dial or the number of times the jog stick is depressed. In the example of moving the jog dial (FIG. 4), a value of “00001011” corresponding to the left direction would be output from the direction value storing unit 12. In the example of moving a jog stick (not shown), a value of “00000101” corresponding to moving the jog stick in an upper left direction would be output from the direction value storing unit 12.

In step 206, the controller 14 determines whether a predetermined period of time has elapsed between movements of the jog key 10. If it is determined that the predetermined period of time has not yet lapsed, the step of sensing the operation of the jog key 10 is repeatedly performed. If it is determined that the predetermined period of time has elapsed, the process proceeds to step 208 during which information relating to the operation of the jog key 10 is set in a jog message from the message setting unit 13.

In step 208, binary data corresponding to the twelve operations, e.g., “00000000 00001100” is provided together with the key value corresponding to the left direction, “00001011” to the message setting unit 13. The message setting unit 13 specifies the operation direction and the number of operations in corresponding areas of the jog messages, e.g., jog messages 20 and 30.

For example, in the jog message 20 shown in FIG. 2A, the message setting unit 13 stores information relating to the number of operations of the jog key 10 in the “SIZE” area 26 and information relating to the operation direction in the “DATA” area 27. Accordingly, if the jog dial 10 is operated twelve times in the left direction as described above, the message setting unit 13 stores the value “00001011” provided by the direction value storing unit 12 in the “DATA” area 27 and the key value “00000000 00001100” in the “SIZE” area 26.

In the jog message 30 shown in FIG. 2B, the direction value storing unit 12 stores the number of operations in the “COUNT (2 Bytes)” area 38 and the operation direction in the “FLAG (1 Byte)” area 39. Similarly, if the jog dial is operated twelve times in the left direction, the message setting unit 13 stores the value “00001011” in the “FLAG (1 Byte)” area 39 and the key value “00000000 00001100” in the “COUNT (2 Bytes)” area 38.

In step 210, the controller 14 extracts the operation direction and/or the number of operations from the jog messages 20 and 30. For example, the controller 14 may extract the operation direction and/or the number of operations from the jog messages 20, 30 after a decoding process of the messages 20, 30.

In step 212, the controller 14 sends information relating to the operation state of the jog key 10 to the screen displaying unit, e.g., the screen shown in FIG. 4, which displays information relating to the operation of the jog key 10 in response to receiving the operation direction and/or the number of operations. For example, the information relating to the operation state of the jog key 10 is indicated on the channel indicator 40 through cursor movement in FIG. 4. If the jog dial 10 is changed from “BSM” to “102.7 MHz” in the display screen of FIG. 4, the cursor immediately moves to “102.7 MHz” of the channel indicator 40 so as to indicate “102.7 MHz.” as the target destination. Accordingly, by sensing both the operation direction of the jog key and the number of times that the jog key is manipulated by the user within a predetermined period of time, e.g., within so many seconds of designating a control function, the controller 14 will permit the terminal device to move the cursor from a first position to a second position after the jog key 10 is controlled by the user.

If the jog dial/jog stick is operated by the user, a jog message is not delivered every time the jog key is operated, but is delivered once to the controller by setting the operation direction and the number of operations of the jog dial/jog stick which are collectively sensed and aggregated within a predetermined period of time in a single jog message sent to the controller 14. Accordingly, the controller can select and alter the cursor position from a first position to a second position with one jog message, thereby avoiding the delayed movement of the cursor that may be caused by the handling information relating to the operation of the jog key in incremental steps, e.g., with a single jog message for each movement of the jog key.

The message setting unit 13 sets the jog messages 20 and 30, and the controller 14 extracts the operation direction and the number of operations from the jog messages 20, 30 provided by the message setting unit 13. Alternatively, if a message setting unit is not used, the controller 14 may directly receive the number of operations from the counter in response to the operation of the jog key 10 and directly access the direction value storing unit 12 for operation direction data. In this case, the operation information in the jog messages 20 and 30 is stored in the memory 16, and the controller 14 may then extract the stored operation direction and the number of operations that will be shown within the display.

Accordingly, the foregoing apparatus and process enables the controller 14 to modify the cursor movement within a display by referring to the operation direction and the number of operations included within the same jog message. The controller 14 may then be used to control cursor translation at the channel indicator so that cursor translation is not delayed while numerous jog messages are being processed, e.g., such as in a system where cursor translation is monitored and controlled incrementally in response to each movement of the jog key.

As described above, with the foregoing apparatus and process for managing key operation information, delays between the actual operation speed of a jog key and the response speed of the associated user interface are controlled. For example, within a predetermined period of time (e.g., 100-200 ms or greater, such as 1-5 seconds), a single jog message is used to characterize control operation of a jog key. Accordingly, rather than having several individual jog messages created, such as, for example, as in the case where ten individual jog messages were created for ten rotations of a jog key occurring within a predetermined time period, the foregoing process reduces processing delay by reducing the number of jog messages created in response to control actions input within a predetermined time period.

Other implementations are within the scope of the following claims.

What is claimed is:

1. An apparatus for managing input key operation information comprising:
a key input unit configured to receive a key input signal from a jog key; and
a controller configured to determine whether the key input signal is a jog message signal and to extract control operation information from the key input signal if the key input signal is the jog message signal, wherein the control operation information includes jog key control direction and a number of jog key control operations from the jog message signal.

2. The apparatus of claim 1, further comprising a counter configured to determine the number of jog key control operations.

3. The apparatus of claim 1, further comprising a direction value storing unit configured to store operation direction information corresponding to the jog key control direction.

4. The apparatus of claim 1, further comprising a message setting unit for setting at least one of the jog key control direction or the number of jog key control operations in the jog message signal.

5. The apparatus of claim 1, wherein the jog key is one or more of a jog dial or a jog stick.

6. The apparatus of claim 1, wherein the key input unit is configured to receive the key input signal within a predetermined time period of the jog key being operated by a user.

7. The apparatus of claim 6, wherein the predetermined time period is within a range of approximately 100 ms to 200 ms.

8. The apparatus of claim 1, wherein the jog message signal includes a data format including a SIZE data area and a DATA data area, and information corresponding to the number of jog key control operations is stored within the SIZE area and information corresponding to the jog key control direction is stored in the “DATA” area.

9. The apparatus of claim 1, wherein the jog message signal includes a data format including one or more of a SRC data area, a MID data area, a DST data area, a COMM data area, a FUNC data area, a SIZE data area, a DATA data area, a COUNT data area, or a FLAG data area.

10. The apparatus of claim 9, wherein information corresponding to the number of jog key control operations is stored in the COUNT area and information corresponding to the jog key control direction is stored in the FLAG area.

11. The apparatus of claim 9, wherein each of the SRC, MID, DST, COMM, FUNC and FLAG data areas is allocated 1 byte.

12. The apparatus of claim 11, wherein each of the SIZE and COUNT data areas is allocated 2 bytes, and the DATA area is allocated 200 bytes.

13. A method for managing key operation information, comprising:
receiving a jog message;
decoding the jog message, wherein the jog message includes jog key control information corresponding to a control operation of a jog key; and
extracting jog key control information from the jog message, wherein the jog key control information includes jog key control direction and a number of jog key control operations.

14. The method of claim 12, further comprising displaying an operation state of the jog key in response to the extracting the jog key control information from the jog message.

15. The method of claim 14, further comprising generating the jog message, wherein generating the jog message includes counting the number of jog key control operations.

16. The method of claim 15, wherein generating the jog message comprises storing operation direction information corresponding to the jog key control direction.

17. The method of claim 16, wherein the jog message is received within a predetermined time period after the control operation of the jog key.

18. The method of claim 17, wherein the predetermined time period is within a range of approximately 100 ms to 200 ms.

19. The method of claim 13, wherein the jog message comprises a SIZE data area and a DATA data area, and information corresponding to the number of jog key control operations is stored within the SIZE area and information corresponding to the jog key control direction is stored in the “DATA” area.

20. The method of claim 13, wherein the jog message comprises one or more of a SRC data area, a MID data area, a DST data area, a COMM data area, a FUNC data area, a SIZE data area, a DATA data area, a COUNT data area, or a FLAG data area.

21. The method of claim 20, wherein information corresponding to the number of jog key control operations is stored in the COUNT area and information corresponding to the jog key control direction is stored in the FLAG area.
